(19) United States
(12) Patent Application Publication
(10) Pub. No.: US 2026/0150088 A1
(43) Pub. Date: May 28, 2026

(54) CONNECTED MODE TIMING AND FREQUENCY ADVANCES FOR NON-TERRESTRIAL NETWORKS

(71) Applicant: QUALCOMM Incorporated, San Diego, CA (US)

(72) Inventors: Chiranjib SAHA, Lakeside, CA (US); Alberto RICO ALVARINO, San Diego, CA (US); Xiao Feng WANG, San Diego, CA (US)

(21) Appl. No.: 18/961,770

(22) Filed: Nov. 27, 2024

(51) Int. Cl. H04W 72/044; H04W 72/23; H04W 84/06; H04W 88/06

(52) U.S. Cl. CPC H04W 72/044; H04W 72/23; H04W 84/06; H04W 88/06

(57) ABSTRACT

Various aspects of the present disclosure generally relate to wireless communication. In some aspects, a user equipment (UE) may receive, from a network node associated with a non-terrestrial network, frequency and timing advance information in accordance with the UE operating in a location-independent communication mode. The UE may transmit one or more uplink communications according to a frequency advance and a timing advance in association with receiving the frequency and timing advance information. Numerous other aspects are described.

### FIELD OF THE DISCLOSURE

Aspects of the present disclosure generally relate to wireless communication and specifically relate to techniques, apparatuses, and methods associated with connected mode timing and frequency advances for non-terrestrial networks.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (cMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at a user equipment (UE). The apparatus may include one or more memories and one or more processors coupled to the one or more memories. The one or more processors may be configured to receive, from a network node associated with a non-terrestrial network (NTN), frequency and timing advance information in accordance with the UE operating in a location-independent communication mode. The one or more processors may be configured to transmit one or more uplink communications according to a frequency advance and a timing advance in association with receiving the frequency and timing advance information.

Some aspects described herein relate to an apparatus for wireless communication at a network node. The apparatus may include one or more memories and one or more processors coupled to the one or more memories. The one or more processors may be configured to transmit, to a UE associated with an NTN, frequency and timing advance information in accordance with the UE operating in a location-independent communication mode. The one or more processors may be configured to receive one or more uplink communications according to a frequency advance and a timing advance in association with transmitting the frequency and timing advance information.

Some aspects described herein relate to a method of wireless communication performed by a UE. The method may include receiving, from a network node associated with an NTN, frequency and timing advance information in accordance with the UE operating in a location-independent communication mode. The method may include transmitting one or more uplink communications according to a frequency advance and a timing advance in association with receiving the frequency and timing advance information.

Some aspects described herein relate to a method of wireless communication performed by a network node. The method may include transmitting, to a UE associated with an NTN, frequency and timing advance information in accordance with the UE operating in a location-independent communication mode. The method May include receiving one or more uplink communications according to a frequency advance and a timing advance in association with transmitting the frequency and timing advance information.

Some aspects described herein relate to a non-transitory computer-readable medium that stores a set of instructions for wireless communication by a UE. The set of instructions, when executed by one or more processors of the UE, may cause the UE to receive, from a network node associated with an NTN, frequency and timing advance information in accordance with the UE operating in a location-independent communication mode. The set of instructions, when executed by one or more processors of the UE, may cause the UE to transmit one or more uplink communications according to a frequency advance and a timing advance in association with receiving the frequency and timing advance information.

Some aspects described herein relate to a non-transitory computer-readable medium that stores a set of instructions for wireless communication by a network node. The set of instructions, when executed by one or more processors of the network node, may cause the network node to transmit, to a UE associated with an NTN, frequency and timing advance information in accordance with the UE operating in a location-independent communication mode. The set of instructions, when executed by one or more processors of the network node, may cause the network node to receive one or more uplink communications according to a frequency advance and a timing advance in association with transmitting the frequency and timing advance information.

Some aspects described herein relate to an apparatus for wireless communication. The apparatus may include means for receiving, from a network node associated with an NTN, frequency and timing advance information in accordance with the UE operating in a location-independent communication mode. The apparatus may include means for transmitting one or more uplink communications according to a frequency advance and a timing advance in association with receiving the frequency and timing advance information.

Some aspects described herein relate to an apparatus for wireless communication. The apparatus may include means for transmitting, to a UE associated with an NTN, frequency and timing advance information in accordance with the UE operating in a location-independent communication mode. The apparatus may include means for receiving one or more uplink communications according to a frequency advance and a timing advance in association with transmitting the frequency and timing advance information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a regenerative satellite deployment and an example of a transparent satellite deployment in a non-terrestrial network (NTN).

FIG. 4 is a diagram illustrating an example of uplink timing advance, in accordance with the present disclosure.

FIG. 5 is a diagram of an example associated with connected mode timing and frequency advances for NTN communications, in accordance with the present disclosure.

FIG. 6 is a diagram illustrating an example associated with user equipment (UE) location information-independent NTN communications, in accordance with the present disclosure.

FIG. 7 is a diagram illustrating an example associated with UE location information-independent uplink frequency and timing advance, in accordance with the present disclosure.

FIG. 8 is a diagram illustrating an example process performed, for example, at a UE or an apparatus of a UE, in accordance with the present disclosure.

FIG. 9 is a diagram illustrating an example process performed, for example, at a network node or an apparatus of a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In some wireless communication networks, a user equipment (UE) may communicate with various types of network nodes. For example, a UE may communicate with a ground-based network node, such as a macro base station, a small cell base station, and/or another type of ground-based base station. In some examples, a UE may communicate with a non-terrestrial network (NTN) network node such as a satellite base station and/or a non-terrestrial communication relay device.

Devices in an NTN may be affected by effects from doppler shift due to the relatively large distances between UEs and NTN nodes, and/or NTN nodes and terrestrial network nodes. Devices in an NTN may additionally or alternatively be affected by variable signal propagation delays due to variability in the distance between UEs and NTN nodes. To compensate for these varying delays, a UE may apply a timing advance to synchronize the transmission time of uplink communications between the UE and the NTN node. The UE may calculate or identify a timing advance based on location information (e.g., information about the location of the UE), such as a global navigation satellite system (GNSS). For example, the UE may connect to an NTN for wireless communication services and may use location information, such as GNSS location information, to maintain uplink synchronization. For example, when the UE is connecting to an NTN for cellular services, such as 5G communication services, the UE may be expected to have GNSS-based location information to ascertain timing synchronization because the UE may use location information. Thus, timing synchronization may be based on a UE capability to receive location information signals from a different NTN, NTN node, and/or constellation of satellites. The UE may use location information to compute the timing delay and/or the Doppler shifts associated with communications between the UE and the NTN node. Thus, the location information may be used to maintain uplink synchronization with the NTN node.

The UE may additionally or alternatively receive a timing advance command to correct a synchronization of communications between the UE and the NTN node. The UE may apply a timing advance correction to uplink communications in response to receiving the timing advance command. Applying the timing advance and/or the timing advance correction to uplink communications may increase the likelihood that an uplink signal is received by the NTN node in the expected time resource, which may avoid time-domain collisions and/or communication misalignment. Similarly, the UE may apply a frequency advance and/or a frequency correction that is indicated by the NTN node and/or calculated by the UE based on timing and/or location information.

A timing advance group may include a group of serving cells that is configured via radio resource control (RRC) signaling and that, for the cells having an uplink that is configured, using the same timing reference cell and the same timing advance value. A timing advance group including a special cell (e.g., a cell that is used for specific purposes, such as network synchronization, positioning, or broadcasting and/or a primary serving cell) of the UE may be referred to as a primary timing advance group, and/or the term secondary timing advance group may refer to other TAGs (e.g., not including the special cell).

In some examples, a UE may communicate with an NTN node but may not have access to UE location information. For example, some emergency and/or disaster scenarios may cut off location information services, some military operations may communicate independently of UE location information for security and/or resource conservation purposes, some indoor applications may have difficulty accessing location information services, among other examples. Further, UEs that may communicate in a location-independent mode may communicate via an NTN and may transition from an idle mode, such as an RRC idle mode, to a connected mode, such as an RRC connected mode. However, in the connected mode, if the UE does not have location information, the UE may be unable to maintain timing synchronization and as such may transition to the idle mode, even when the UE has information to communicate with the NTN node in the connected mode.

Various aspects relate generally to location information-independent timing and frequency advances for NTN communications. Some aspects more specifically relate to a UE, in an RRC connected mode or in another mode of operation in which UE-location information is unavailable, applying and/or calculating frequency and/or timing advances for NTN uplink communications to maintain synchronization and remain in the connected mode. In some aspects, an NTN node may transmit, and the UE may receive, frequency and timing advance information in accordance with the UE operating in a location-independent communication mode (e.g., an RRC connected mode, a GNSS information-less communication mode, or a UE-location information-less communication mode). In some aspects, the UE may transmit, and the NTN node may receive, one or more uplink communications according to a frequency advance and a timing advance in association with receiving the frequency and timing advance information. In some aspects, the frequency and timing advance information and/or the timing advance information may include a reference location, and the UE may calculate the frequency advance and/or the timing advance in association with receiving the reference location. In some aspects, the frequency and timing advance information may include a cell-specific timing advance and/or frequency advance, a UE-specific timing advance and/or frequency advance, and/or a timing advance and/or frequency advance that is common to a group of UEs, such as a timing advance group.

In some aspects, the NTN node may transmit, and the UE may receive, a frequency advance command (FAC) including a frequency correction for uplink communications. In some aspects, the UE may transmit, and the NTN node may receive, an additional one or more uplink communications according to the frequency correction and/or a timing correction that is calculated in association with receiving the frequency advance command. In some aspects, the UE may calculate the timing correction, as a function of the frequency advance, the frequency correction, and/or the timing advance. In some aspects, the NTN node may transmit, and the UE may receive, during a first time resource, a frequency advance command including a frequency correction associated with uplink communications. In such aspects, the UE may transmit, and the NTN node may receive, during a second time resource, an additional one or more uplink communications according to the frequency correction and a timing correction that is calculated in association with receiving the frequency advance command, wherein the second time resource occurs at a time offset, from the first time resource, that includes a downlink message processing duration and an uplink message preparation duration.

Particular aspects of the subject matter described in this disclosure can be implemented to realize one or more of the following potential advantages. In some examples, the described techniques can be used to increase reliability of NTN communications, maintain timing synchronization and/or frequency alignment between the UE and an NTN node, and/or increase coverage. For example, by communicating frequency and timing advance information in accordance with the UE operating in a location-independent communication mode, the UE may obtain synchronization and/or alignment information without needing to connect to location information services. By communicating one or more uplink communications according to a frequency advance and a timing advance in association with receiving the frequency and timing advance information, the UE may increase a likelihood that the one or more uplink communications will be successfully received by the NTN node while the UE is operating in the location information-independent connected mode. By communicating the frequency advance command including a frequency correction for uplink communications, the UE may maintain uplink frequency alignment and may avoid transitioning into the idle mode. By calculating the timing correction, as a function of the frequency advance, the frequency correction, and/or the timing advance, the UE may maintain uplink timing synchronization without connecting to location services and while maintaining a communication link in the connected mode and avoiding time-domain collisions and/or communication misalignment. By communicating the additional one or more uplink communications according to the frequency correction and/or a timing correction that is calculated in association with receiving the frequency advance command, the UE may increase communication efficiency and avoid transitioning into the idle mode. By communicating, during the second time resource that occurs at the time offset that includes the downlink message processing duration and the uplink message preparation duration, the UE may successfully decode downlink messages and schedule one or more uplink messages according to the downlink message in a time resource indicated by the NTN node.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (cMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, NTN deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

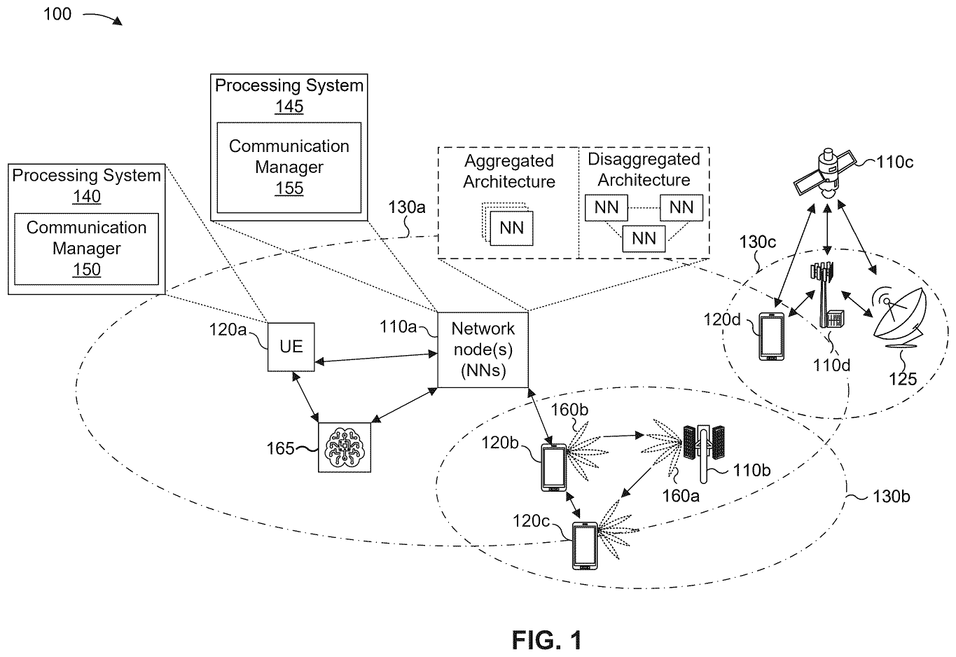

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, a network node 110c and a network node 110d. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

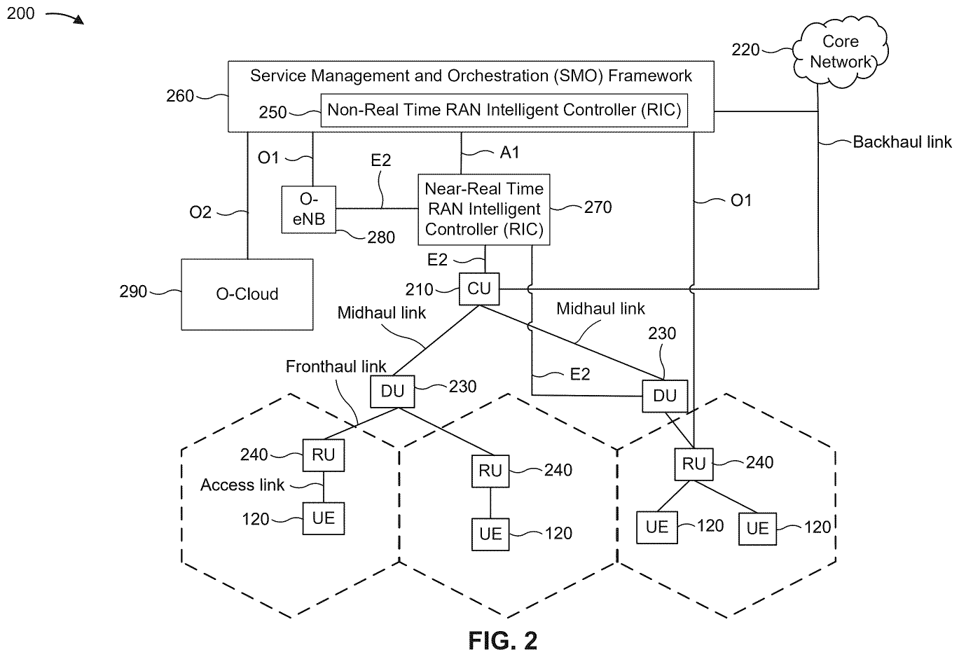

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a GNSS device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, cMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (LI)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

As indicated above, a network node 110 may be a terrestrial network node 110 (for example, a terrestrial base station or entity of a disaggregated base station) or an NTN node 110. In the example shown in FIG. 1, the network node 110c may be an NTN node 110 and the cell 130c may be an NTN cell. For example, the wireless communication network 100 may include one or more NTN deployments including an NTN node 110 and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN node 110 may communicate directly and/or indirectly with other entities in the wireless communication network 100 using NTN communication. The other entities may include UEs 120 (for example, the UE 120d), other NTN nodes 110 in the one or more NTN deployments, other types of network nodes 110 (for example, stationary, terrestrial, and/or ground-based network nodes, such as the network node 110d), relay stations, and/or one or more components and/or devices included in or coupled with a core network of the wireless communication network 100. For example, an NTN node 110 may communicate with a UE 120 via a service link (for example, where the service link includes an access link). Additionally or alternatively, an NTN node 110 may communicate with a gateway 125 (for example, a terrestrial node providing connectivity for the NTN node 110 to a data network or a core network) via a feeder link (for example, where the feeder link is associated with an N2 or an N3 interface). Additionally or alternatively, NTN nodes 110 may communicate directly with one another via an inter-satellite link (ISL). In some examples, an NTN deployment may be transparent (for example, where the NTN node 110 operates in a similar manner as a repeater or relay and/or where an access link does not terminate at the NTN node 110). In some other examples, an NTN deployment may be regenerative. For example, an access link may terminate at the NTN node 110, and the NTN node 110 may regenerate a signal (such as by performing signal processing or enhancement, which may include error correction, modulation or demodulation, or amplification).

In some aspects, the UE 120 may include a communication manager 150. As described in more detail elsewhere herein, the communication manager 150 may receive, from a network node 110 associated with an NTN, frequency and timing advance information in accordance with the UE 120 operating in a location-independent communication mode; and transmit one or more uplink communications according to a frequency advance and a timing advance in association with receiving the frequency and timing advance information. Additionally, or alternatively, the communication manager 150 may perform one or more other operations described herein.

In some aspects, the network node 110 may include a communication manager 155. As described in more detail elsewhere herein, the communication manager 155 may transmit, to a UE 120 associated with an NTN, frequency and timing advance information in accordance with the UE 120 operating in a location-independent communication mode; and receive one or more uplink communications according to a frequency advance and a timing advance in association with transmitting the frequency and timing advance information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

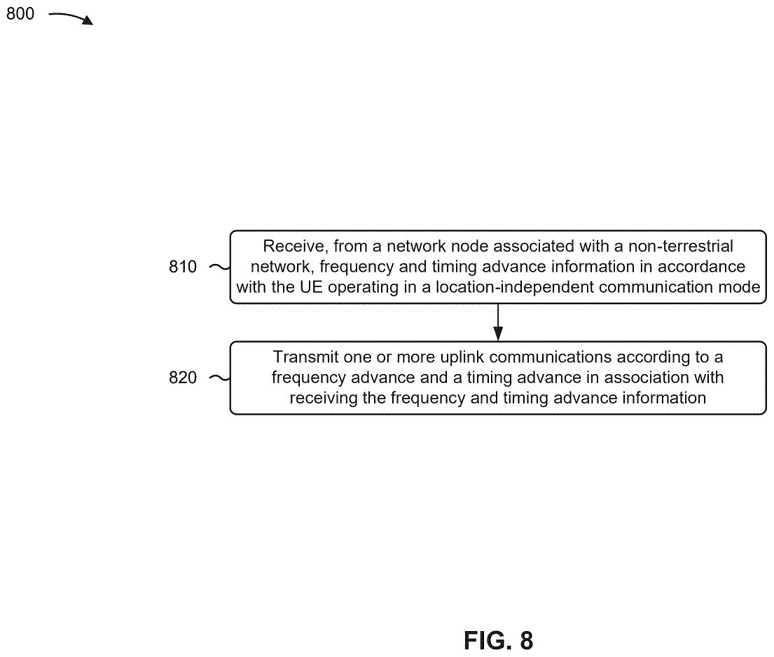

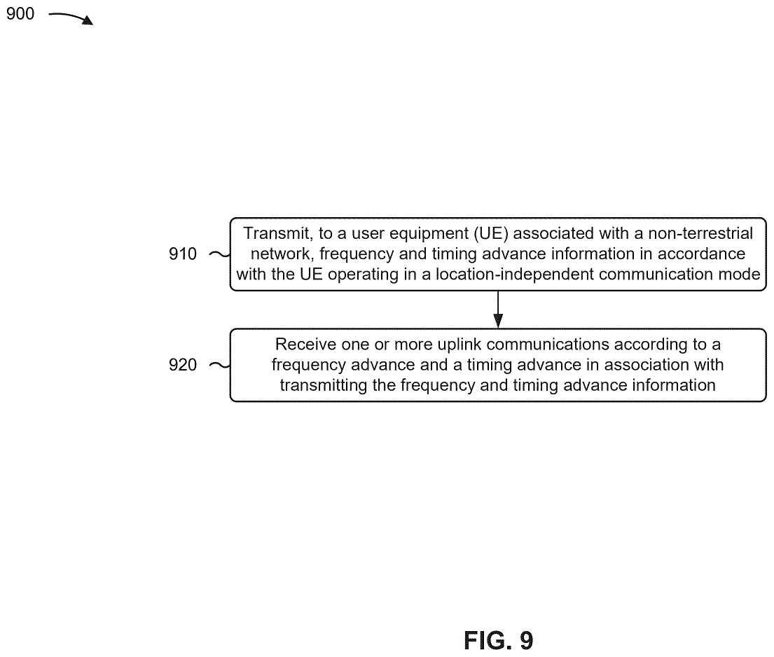

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with UE location information-independent (e.g., GNSS-free) timing and frequency advances for NTN communications, as described in more detail elsewhere herein. For example, the processing system 145 of the network node 110, the processing system 140 of the UE 120, the CU 210, the DU 230, or the RU 240 may perform or direct operations of, for example, process 800 of FIG. 8, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8, process 900 of FIG. 9, or other processes as described herein. In some examples, executing instructions may include running the instructions, converting the instructions, compiling the instructions, and/or interpreting the instructions, among other examples.

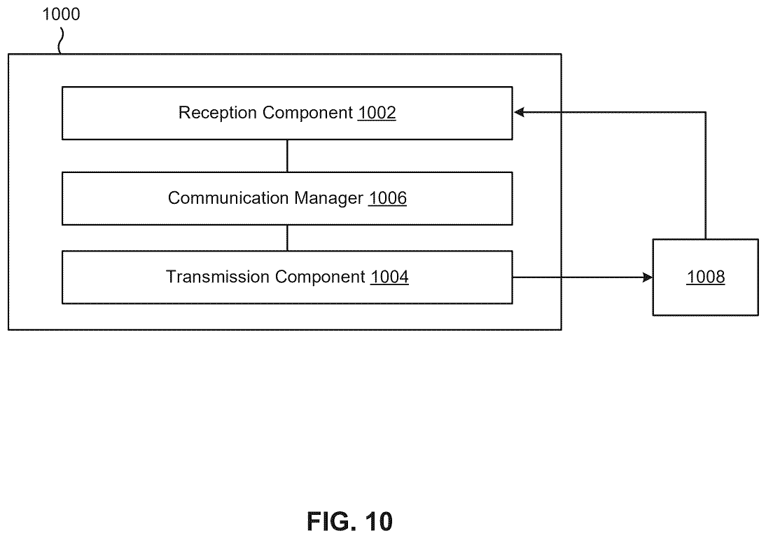

In some aspects, the UE 120 includes means for receiving, from a network node 110 associated with an NTN, frequency and timing advance information in accordance with the UE 120 operating in a location-independent communication mode; and/or means for transmitting one or more uplink communications according to a frequency advance and a timing advance in association with receiving the frequency and timing advance information. The means for the UE to perform operations described herein may include, for example, one or more of communication manager 150, processing system 140, a radio, one or more RF chains, one or more transceivers, one or more antennas, one or more modems, a reception component (for example, reception component 1001 depicted and described in connection with FIG. 10), and/or a transmission component (for example, transmission component 1004 depicted and described in connection with FIG. 10), among other examples.

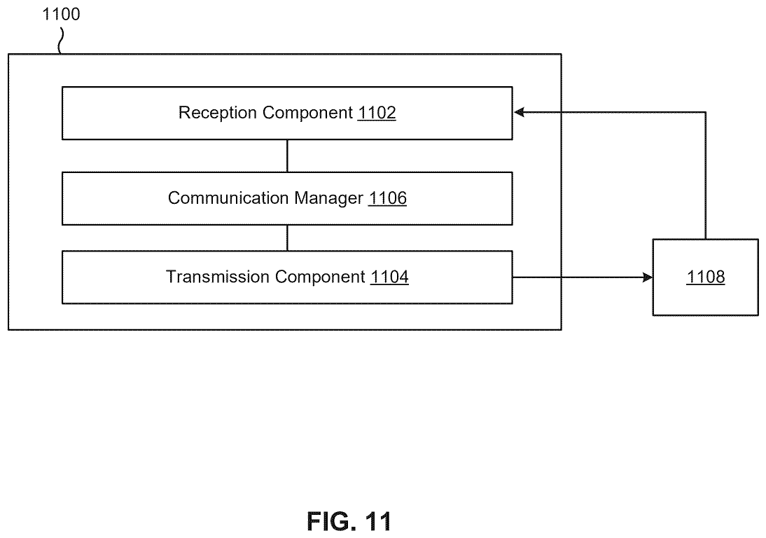

In some aspects, the network node 110 includes means for transmitting, to a UE 120 associated with an NTN, frequency and timing advance information in accordance with the UE 120 operating in a location-independent communication mode; and/or means for receiving one or more uplink communications according to a frequency advance and a timing advance in association with transmitting the frequency and timing advance information. The means for the network node 110 to perform operations described herein may include, for example, one or more of communication manager 155, processing system 145, a radio, one or more RF chains, one or more transceivers, one or more antennas, one or more modems, a reception component (for example, reception component 1102 depicted and described in connection with FIG. 11), and/or a transmission component (for example, transmission component 1104 depicted and described in connection with FIG. 11), among other examples.

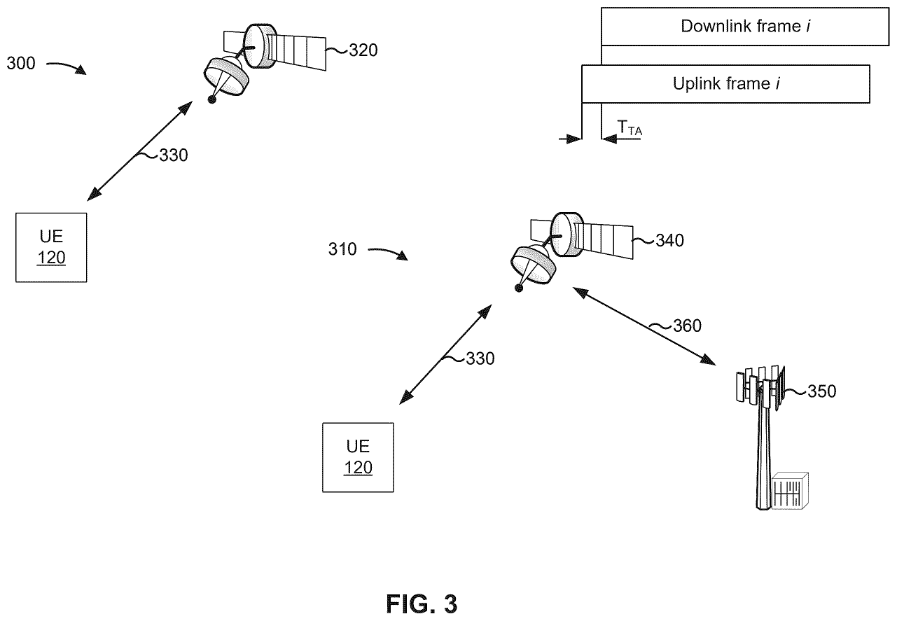

FIG. 3 is a diagram illustrating an example 300 of a regenerative satellite deployment and an example 310 of a transparent satellite deployment in an NTN.

Example 300 shows a regenerative satellite deployment. In example 300, a UE 120 is served by a satellite 320 via a service link 330. For example, the satellite 320 may include and/or be an example of an NTN node 110 (e.g., network node 110c described with reference to FIG. 1) or a gNB. In some aspects, the satellite 320 may be referred to as a non-terrestrial base station, a regenerative repeater, or an on-board processing repeater. In some aspects, the satellite 320 may demodulate an uplink radio frequency signal, and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite. The satellite 340 may relay a signal received from gateway 350 via a feeder link 360. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 330 to a frequency of the uplink radio frequency transmission on the feeder link 360, and may amplify and/or filter the uplink radio frequency transmission. In some aspects, the UEs 120 shown in example 300 and example 310 may be associated with a GNSS capability or a Global Positioning System (GPS) capability, though not all UEs have such capabilities. The satellite 340 may provide a cell that covers the UE 120.

The service link 330 may include a link between the satellite 340 and the UE 120, and may include one or more of an uplink or a downlink. The feeder link 360 may include a link between the satellite 340 and the gateway 350, and may include one or more of an uplink (e.g., from the UE 120 to the gateway 350) or a downlink (e.g., from the gateway 350 to the UE 120).

The feeder link 360 and the service link 330 may each experience Doppler effects due to the movement of the satellites 320 and 340, and potentially movement of a UE 120. These Doppler effects may be significantly larger than in a terrestrial network. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency.

The UE 120 may calculate a timing advance for uplink communications based one or as a function of a location of the UE 120 (e.g., obtained via location services, such as GNSS). For a time continuous signal, sₗ^{(p,μ)}(t), on antenna port p and subcarrier spacing configuration μ for OFDM symbol l in a subframe, and for an uplink frame number, i, transmission by a UE 120 may start at a time, T_{TA} before the start of a corresponding downlink frame at the UE 120, where

$${T}_{T A} = ( {N}_{TA ,} + {N}_{TA , offset} + {N}_{T A , adj common} + {N}_{T A , adj UE} ) {T}_{c}$$

and N_{TA} is a timing advance between downlink and uplink; N_{TA,offset} is a fixed offset used to calculate the timing advance; N_{TA,adj common}, is a network-controlled timing correction and may be derived from higher-layer parameters, such as ta-Common, ta-CommonDrift, and ta-CommonDriftVariant when configured; N_{TA,adj UE} is a UE-derived timing correction and may be computed by the UE 120 based on UE position and serving-satellite-ephemeris-related higher-layers parameters when configured; and T_{c} is a basic time unit for wireless communications.

The satellite 320 may transmit a timing advance command (TAC), which can be triggered by an inaccurate location estimation by the UE 120 (e.g., which may result in an error in the UE-calculated TA) and/or some other issue with a factor of the timing advance, such as the common TA (e.g., the feeder link common TA). For example, the UE 120 may receive a timing advance command to correct a synchronization of communications between the UE 120 and the satellite 320. The UE 120 may apply a timing advance correction to uplink communications in response to receiving the timing advance command. Applying the timing advance and/or the timing advance correction to uplink communications may increase the likelihood that an uplink signal is received by the satellite 320 in the expected time resource, which may avoid time-domain collisions and/or communication misalignment. The UE 120 may apply a frequency advance and/or a frequency correction that is indicated by the NTN node and/or calculated by the UE 120 based on timing and/or location information.

However, in some examples, the UE 120 may communicate with the satellite 320 but may not have access to UE location information. For example, some emergency and/or disaster scenarios may cut off location information services, some military operations may communicate independently of UE location information for security and/or resource conservation purposes, some indoor applications may have difficulty accessing location information services, among other examples. Further, the UE 120 may communicate via with the satellite 320 in the location-independent mode and may transition from an idle mode, such as an RRC idle mode, to a connected mode, such as an RRC connected mode. However, in the connected mode, if the UE 120 does not have location information, the UE 120 may be unable to maintain timing synchronization and, as such, may transition to the idle mode, even when the UE 120 has information to communicate with the satellite 320 in the connected mode.

As indicated above, FIG. 3 is provided as an example. Other examples may differ from what is described with regard to FIG. 3.

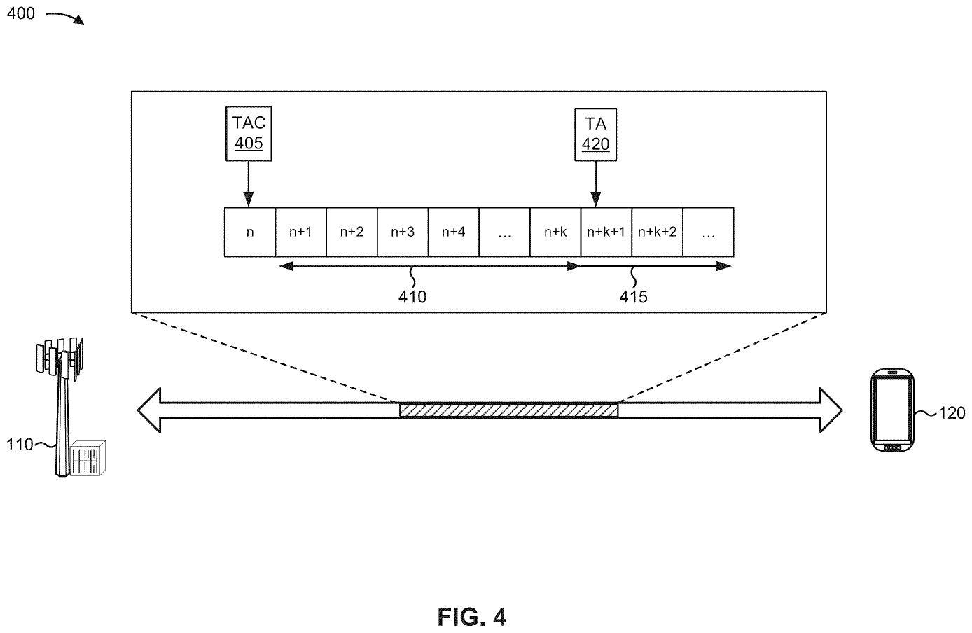

FIG. 4 is a diagram illustrating an example 400 of uplink timing advance, in accordance with the present disclosure. As shown in FIG. 4, a network node 110 and a UE 120 may communicate with one another. The network node 110 may be an example of an NTN node 110 described herein.

The UE 120 may receive a timing advance command 405 from the network node 110 via a time resource, n. For a timing advance command received via time resource, n, the corresponding advance of the uplink transmission timing applies from the beginning of uplink time resource, n+k+1, where k is an amount of time 410 used to process downlink data messages and prepare uplink messages. The time resource, n may be a lastly occurring time resource among uplink time resources that overlap with the downlink time resources, where the downlink message includes the timing advance command.

The UE 120 may apply a timing advance 420 starting with the time resource, n+k+1 and may apply the timing advance 420 to any uplink communications transmitted during the time span 415 (e.g., any time resource occurring after the time resource, n+k+1) and/or until an additional timing advance command is received.

The timing advance may be derived as described with reference to FIG. 3 and/or may be based on and/or associated with a location of the UE 120 (e.g., calculated using location information of the UE 120 obtained via satellite-based location information).

As indicated above, FIG. 4 is provided as an example. Other examples may differ from what is described with respect to FIG. 4.

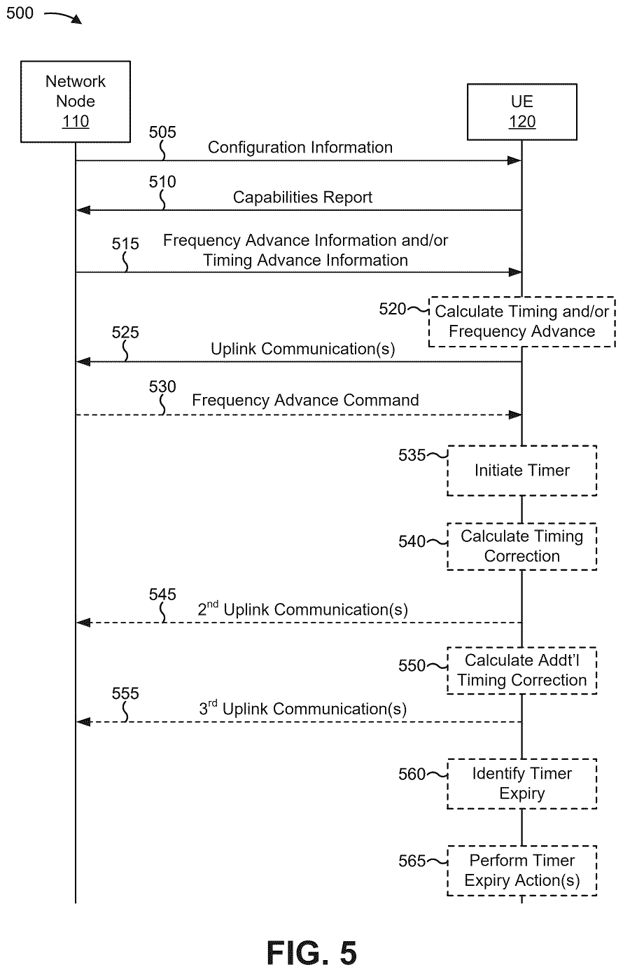

FIG. 5 is a diagram of an example 500 associated with connected mode timing and frequency advances for NTN communications, in accordance with the present disclosure. As shown in FIG. 5, a network node 110 (e.g., a network node 110 as described with reference to FIG. 1, an NTN node 110 as described with reference to FIGS. 3 and 4, a CU, a DU, and/or an RU) may communicate with a UE 120 (e.g., UE 120 described in connection with FIGS. 1-4). In some aspects, the network node 110 and the UE 120 may be part of a wireless network (e.g., wireless network 100). The UE 120 and the network node 110 may have established a wireless connection prior to operations shown in FIG. 5.

As shown by reference number 505, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may indicate that the UE 120 is to perform location information-independent NTN communications. For example, a location independent communication mode may include a GNSS information-less communication mode, an RRC mode, and/or a UE location information-less communication mode. In some aspects, the configuration information may include a control message indicating a quantity of groups corresponding to a quantity of frequency advance commands for communicating respective sets of uplink communications. For example, the UE 120 may belong to a timing advance group and may receive a timing advance group indication. In some aspects, the configuration information may include an indication of a timer associated with uplink frequency synchronization.

The UE 120 may configure itself based at least in part on the configuration information. In some aspects, the UE 120 may be configured to perform one or more operations described herein based at least in part on the configuration information.

As shown by reference number 510, the UE 120 may transmit, and the network node 110 may receive, a capabilities report. The capabilities report may indicate whether the UE 120 supports a feature and/or one or more parameters related to the feature. For example, the capability information may indicate a capability and/or parameter for the UE to derive timing advance values and/or timing correction values from frequency advance and/or correction values. As another example, the capabilities report may indicate a capability and/or parameter for maintaining frequency alignment and/or timing synchronization in location-less communication modes. One or more operations described herein may be based on capability information of the capabilities report. For example, the UE 120 may perform a communication in accordance with the capability information, or may receive configuration information that is in accordance with the capability information.

In some aspects, the configuration information described in connection with reference number 505 and/or the capabilities report described in connection with reference number 510 may include information transmitted via multiple communications. Additionally, or alternatively, the network node 110 may transmit the configuration information, or a communication including at least a portion of the configuration information, before and/or after the UE 120 transmits the capabilities report. For example, the network node 110 may transmit a first portion of the configuration information before the capabilities report, the UE 120 may transmit at least a portion of the capabilities report, and the network node 110 may transmit a second portion of the configuration information after receiving the capabilities report.

As shown by reference number 515, the network node 110 may transmit, and the UE 120 may receive, frequency advance information and/or timing advance information. In some aspects, the network node 110 may transmit, and the UE 120 may receive, frequency advance and timing advance information in accordance with the UE 120 operating in a location-independent communication mode (e.g., a GNSS-free communication mode or location information-less communication mode). For example, the information may include a frequency advance, a timing advance, information for obtaining a frequency advance, and/or information for obtaining a timing advance. In some aspects, the UE 120 may receive an SIB (e.g., the SIB described in connection with reference number 505 and/or an additional SIB) including the frequency and/or timing advance information and/or a UE-specific message (e.g., via the configuration information described in connection with reference number 505 and/or an additional message) including the frequency and/or timing advance information.

In some aspects, the frequency advance may include a frequency offset for frequency-domain scheduling of uplink communications to be transmitted to the network node 110 and/or transmitted via a communication relay device to the network node 110 associated with the NTN. In some aspects, the timing advance may include a timing offset for time-domain scheduling of uplink communications to be transmitted to the network node 110 and/or transmitted via a communication relay device to the network node 110 associated with the NTN. In some aspects, the frequency advance may be a UE-specific frequency advance, and/or the timing advance may be a UE-specific timing advance. In some other aspects, the frequency advance may be a cell-specific frequency advance, and/or the timing advance may be a cell-specific timing advance.

In some aspects, the frequency and timing advance information may include an indication of the frequency advance, an indication of the timing advance, one or more derivatives of the frequency advance, one or more derivatives of the timing advance, a validity time value, a reference location for calculating the frequency advance, a drift associated with the reference location, or a drift rate associated with the reference location.

As shown by reference number 520, in some aspects, the UE 120 may calculate a timing advance and/or may calculate a frequency advance. For example, the frequency and/or timing advance information may include a reference location. In such aspects, the UE 120 may calculate the frequency advance and/or the timing advance in association with receiving the reference location. For example, the UE 120 may calculate the common frequency advance (FA) and/or the common timing advance (TA) using the reference location.

As shown by reference number 525, the UE 120 may transmit, and the network node 110 may receive, one or more uplink communications. For example, the UE 120 may transmit, and the network node 110 may receive, one or more uplink communications according to a frequency advance and a timing advance in association with receiving the frequency and timing advance information. In some aspects, the one or more uplink communications may include a PUSCH signal, a PUCCH signal, and/or an SRS.

As shown by reference number 530, in some aspects, the network node 110 may transmit, and the UE 120 may receive, a frequency advance command. For example, the network node 110 may transmit, and the UE 120 may receive, a frequency advance command including a frequency correction for (e.g., associated with, to be applied to) uplink communications.

In some aspects, the UE 120 receiving the frequency advance command may include receiving, via a random access message, a first frequency correction for random access communications, and/or receiving, via a medium access control message, a second frequency correction for connected mode communications. For example, the network node 110 may transmit two different and/or varying FACs, including an initial frequency advance command via a random access response while communicating with the UE 120 via PRACH resources for location information-independent communications, and/or including a second frequency advance command via MAC-CE.

In some aspects, the network node 110 may transmit, and the UE 120 may receive, during a first time resource, a frequency advance command including a frequency correction for uplink communications during a second time resource.

In some aspects, the network node 110 may transmit, and the UE 120 may receive, a first frequency advance command including a first frequency correction for a first set of one or more uplink communications, and a second frequency advance command including a second frequency correction for a second set of one or more uplink communications. In such aspects, the UE 120 may transmit, and the network node 110 may receive, the first set of one or more uplink communications according to the first frequency correction and a first timing correction that is calculated in association with receiving the first frequency advance command and/or may transmit the second set of one or more uplink communications according to the second frequency correction and a second timing correction that is calculated in association with receiving the second frequency advance command. In such aspects, the first set of one or more uplink communications and/or the second set of one or more uplink communications may each be associated with a respective uplink carrier frequency, a respective network node 110, a respective timing advance group, a respective frequency advance group, and/or a respective serving cell. A frequency advance group may include a group of serving cells that is configured via RRC signaling and that, for the cells having an uplink that is configured, using the same frequency reference cell and the same frequency advance value. A frequency advance group including a special cell (e.g., a cell that is used for specific purposes, such as network synchronization, positioning, or broadcasting and/or a primary serving cell) of the UE may be referred to as a primary frequency advance group, and/or the term secondary frequency advance group may refer to other frequency advance groups (e.g., not including the special cell).

As shown by reference number 535, in some aspects, the UE 120 may initiate a timer. The network node 110 may transmit, and the UE 120 may receive, via the configuration information described in connection with reference number 505, the frequency advance command described in connection with reference number 530, and/or the frequency advance information and/or the timing advance information described in connection with reference number 515, an indication of a timer associated with uplink frequency synchronization. For example, the network node 110 may provide a configurable timer, such as frequencyAlignmentTimer. In such aspects, the UE 120 may initiate (e.g., start, restart) the timer each time it receives a frequency advance command, such as the frequency advance command described in connection with reference number 530. In some aspects, if the UE 120 fails to receive a frequency advance command within an expiry duration of the timer, the UE 120 (e.g., a MAC entity associated with the UE 120) may identify a loss in UL synchronization, as further described in connection with reference number 560.

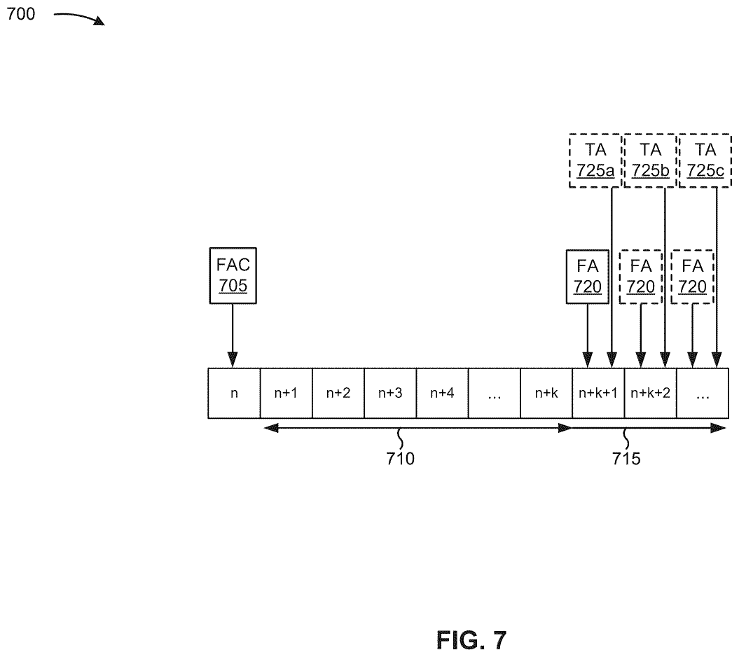

As shown by reference number 540, in some aspects, the UE 120 may calculate a timing correction. For example, the UE 120 may calculate the timing correction, as a function of the frequency advance (e.g., described in connection with reference number 515), the frequency correction (e.g., described in connection with reference number 530), and the timing advance (e.g., described in connection with reference number 515), for the uplink communications during the second time resource. In such aspects, the second time resource may be offset from the first time resource by a quantity of time resources. As a result, the UE 120 may compute the timing advance from the frequency advance for one or more time resources occurring at an offset from receiving the frequency advance command (as described in further detail with reference to FIG. 7).

As shown by reference number 545, in some aspects, the UE 120 may transmit, and the network node 110 may receive, a second set of one or more uplink communications. For example, the UE 120 may transmit, and the network node 110 may receive, an additional one or more uplink communications according to the frequency correction and a timing correction that is calculated in association with receiving the frequency advance command. In some aspects, the UE 120 transmitting the additional one or more uplink communications according to the frequency correction and the timing correction may include the UE 120 transmitting the additional one or more uplink communications in association with applying the frequency correction to an uplink carrier frequency associated with transmitting the one or more uplink communications. For example, the UE 120 may apply the frequency correction to an uplink carrier frequency.

In some other aspects, the UE 120 transmitting the additional one or more uplink communications according to the frequency correction and the timing correction may include the UE 120 transmitting the additional one or more uplink communications in association with applying the frequency correction to a baseband frequency associated with transmitting the one or more uplink communications. For example, the UE 120 may apply the frequency correction to a baseband frequency by using a phase ramp in the time domain.

In some aspects, the UE 120 may transmit, and the network node 110 may receive, during the second time resource, an additional set of one or more uplink communications according to the frequency correction (e.g., described in connection with reference number 530) and the timing correction (e.g., described in connection with reference number 540).

In some aspects, communicating the one or more uplink communications according to the frequency advance and the timing advance, described in connection with reference number 525, may include the UE 120 transmitting, via an uplink frequency carrier in accordance with the frequency advance, the one or more uplink communications. In such aspects, the UE 120 may transmit, and the network node 110 may receive, via the uplink carrier frequency in accordance with the frequency advance, the additional one or more uplink communications in association with applying the frequency correction to a baseband frequency associated with transmitting the one or more uplink communications. For example, the UE 120 may apply the common frequency advance to an uplink frequency carrier associated with uplink communication between the UE 120 and the NTN node 110 and/or may apply one or more frequency corrections to a baseband frequency associated with uplink communication between the UE 120 and the NTN node 110.

In some aspects, based on receiving the frequency advance command during a first resource as described in connection with reference number 520, the UE 120 may transmit, and the network node 110 may receive, during a second time resource, an additional one or more uplink communications according to the frequency correction and a timing correction that is calculated in association with receiving the frequency advance command. In such examples, the second time resource may occur at a time offset, from the first time resource, that includes a downlink message processing duration and an uplink message preparation duration. For example, the UE 120 may receive a frequency advance command during a first time resource (e.g., a slot, frame, subframe, among other examples), n, and may apply a frequency advance during a second time resource, n+k₁+k₂, where k₁ is a duration of time used to process (e.g., receive, decode) a downlink data message (e.g., PDSCH message), and k₂ is a duration of time used to process (e.g., transmit, buffer) an uplink data message (e.g., PUSCH message). Additionally or alternatively, the UE 120 may apply a timing advance during the second time resource, n+k+k₂. In some aspects, the UE 120 may calculate a timing advance to apply to each time resource occurring subsequently to the second time resource, independently from additional frequency advance commands.

As shown by reference number 550, in some aspects, the UE 120 may calculate an additional timing correction. The UE 120 may calculate an additional timing correction, as a function of the frequency correction and the timing correction, for uplink communications during a third time resource that is subsequent to the second time resource. For example, the UE 120 may calculate a new timing advance and/or timing advance correction for each time resource (e.g., slot) occurring after the second time resource.

As shown by reference number 555, in some aspects, the UE 120 may transmit, and the network node 110 may receive, a third set of one or more uplink communications. For example, the UE 120 may transmit, and the network node 110 may receive, during the third time resource, a second additional set of one or more uplink communications according to the frequency correction and the additional timing correction.

As shown by reference number 560, in some aspects, the UE 120 may identify a timer expiry. For example, the UE 120 may fail to receive an additional FAC, within an active duration of the timer described in connection with reference number 535, after initiating the timer in response to the frequency advance command described in connection with reference number 530. As a result, the UE 120 (e.g., a MAC entity associated with the UE 120) may identify a loss in UL synchronization. In some aspects, the UE 120 may identify that a first timer associated with uplink timing and/or frequency synchronization for a secondary timing and/or frequency advance group has expired in association with a second timer, associated with uplink timing and/or frequency synchronization for at least one of the secondary timing advance group or a primary timing advance group, expiring. For example, the UE 120 may identify that the FrequencyAlignmentTimer associated with a secondary timing and/or frequency advance group is expired.

As shown by reference number 565, in some aspects, the UE 120 may perform one or more time expiry actions. For example, based on or otherwise in association with identifying the timer expiry, the UE 120 may perform at least one action in association with the timer expiring. In some aspects, the at least one action may include deleting contents in each of a quantity of buffers of the UE that are associated with a serving cell in a primary timing advance group. For example, the UE 120 may flush each HARQ buffer (e.g., all HARQ buffers) associated with each serving cell (e.g., all serving cells) that belongs to a primary timing advance group.

In some aspects, the at least one action may include deleting contents in each of a quantity of buffers of the UE that are associated with a serving cell in a secondary timing advance group. For example, the UE 120 may flush each HARQ buffer (e.g., all HARQ buffers) associated with each serving cell (e.g., all serving cells) that belongs to a secondary timing advance group.

In some aspects, the at least one action may include transmitting a radio resource control message, to suspend communication of uplink control messages, to each serving cell associated with the UE. For example, the UE 120 may notify an RRC entity of the network node 110 to release a PUCCH for each serving cell (e.g., all serving cells) associated with the UE 120.

In some aspects, the at least one action may include transmitting a radio resource control message, to suspend communication of sounding reference signal messages, to each serving cell associated with the UE 120. For example, the UE 120 may notify an RRC entity of the network node 110 to release SRSs for each serving cell (e.g., all serving cells) associated with the UE 120.

In some aspects, the at least one action may include deleting one or more downlink assignments. For example, the UE 120 may clear any configured downlink assignments associated with a primary serving cell of the UE 120.

In some aspects, the at least one action may include deleting one or more uplink resource grants. For example, the UE 120 may clear any uplink grant associated with the primary serving cell of the UE 120.

In some aspects, the at least one action may include identifying that each timer, associated with uplink timing synchronization, of the UE has expired. For example, the UE 120 may consider that each running alignment timer, such as each timeAlignmentTimer associated with the primary timing advance group and/or the secondary timing advance group, to be expired.

In some aspects, the UE 120 may perform at least one action in association with the first timer (e.g., the first timer that is associated with uplink timing and/or frequency synchronization for the secondary timing and/or frequency advance group) expiring. In some aspects, the at least one action may include deleting contents in each of a quantity of buffers of the UE 120 that are associated with a serving cell in the secondary timing and/or frequency advance group. For example, the UE 120 may flush all HARQ buffers for all the serving cells belonging to the secondary timing and/or frequency advance group. In some aspects, the at least one action may include transmitting an RRC message, to suspend communication of SRS messages, to each serving cell in the secondary timing and/or frequency advance group. For example, the UE 120 may notify an RRC entity associated with the network node 110 to release SRSs for all the serving cells belonging to the secondary timing and/or frequency advance group.

As indicated above, FIG. 5 is provided as an example. Other examples may differ from what is described with respect to FIG. 5.

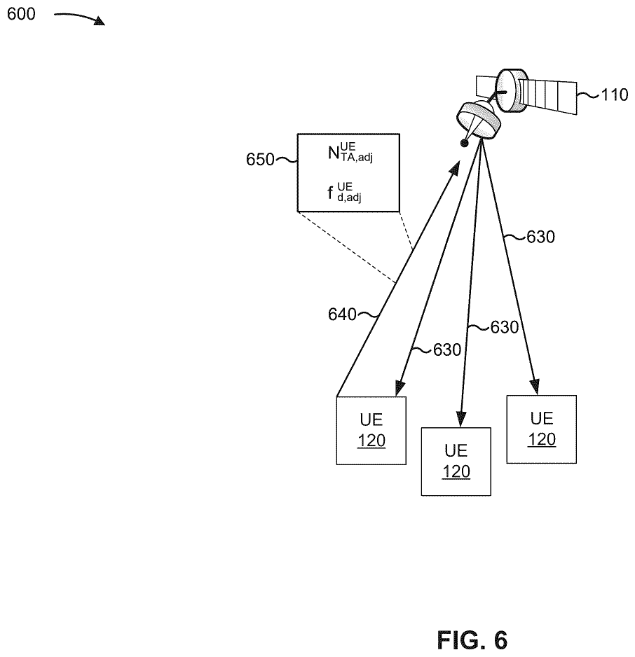

FIG. 6 is a diagram illustrating an example 600 associated with UE location information-independent NTN communications, in accordance with the present disclosure. As shown in FIG. 6, example 600 includes communication between an NTN node 110 and UEs 120. In some aspects, NTN node 110 and UEs 120 may be included in a wireless network, such as wireless network 100. NTN node and UEs 120 may communicate via a wireless access link, which may include an uplink and a downlink.

The NTN node 110 may transmit, via downlinks 630, frequency and/or timing advance information to one or more UEs 120 operating in a UE location information independent communication mode (e.g., GNSS-less connected UEs 120). In some aspects, the frequency and/or timing advance information may include or be communicated via an SIB, and/or UE-dedicated signaling.

The NTN node 110 may transmit, via downlinks 630, a common TA, N_{TA,adj}^{UE} and/or a common FA, f_{d,adj}^{UE} and to the one or more UEs 120. In some aspects, the NTN node 110 may transmit an indication of an n^{th} order derivative of the indicated TA and/or FA (e.g., TA, first derivative of TA (e.g., FA), second derivative of TA (e.g., TA drift rate)), and/or a validity indicator (e.g., an indication of how long each parameter is valid from the time of reception).

Additionally or alternatively, the NTN node 110 may transmit, via downlinks 630, a reference location (e.g., coordinates) of a reference point common to each of the UEs 120. In such aspects, the UE 120 may compute the common TA and/or common FA. Additionally or alternatively, the NTN node 110 may include an indication of how the reference location is changing with time (e.g., location drift, location drift rate), and/or a validity indicator.

The UE 120a (or, any other UE 120 shown in FIG. 6) may apply the common TA and/or the common FA 650 while transmitting uplink signals 640 (e.g., PUCCH, PUSCH, SRS) in the UE location information-independent communication mode. The common TA and the common FA may include a UE-specific (e.g., specific to one or more UEs) common TA and FA, which may be different than a common TA and/or FA as used in association with feeder link delay.

As indicated above, FIG. 6 is provided as an example. Other examples may differ from what is described with respect to FIG. 6.

FIG. 7 is a diagram illustrating an example 700 associated with UE location information-independent uplink frequency and timing advance, in accordance with the present disclosure. Example 700 illustrates communication timing between an NTN node (e.g., an NTN node 110 as described with reference to FIGS. 1, 4, and 5, a satellite-based network node 110 described with reference to FIGS. 3 and 6, or another example of an NTN node) and a UE (e.g., UE 120 described with reference to FIGS. 1-6). In some aspects, the NTN node and the UE may be included in an NTN, such as NTN 110c described with reference to FIG. 1.

A UE may receive a frequency advance command from an NTN while communicating in the connected mode. For example, the UE may receive a frequency advance command 705 from the NTN node during a time resource (e.g., slot), n. For example, the UE may be operating in a location-independent communication mode (e.g., GNSS-less mode) and may receive (e.g., from the NTN node) the frequency advance command 705. The frequency advance command 705 may indicate that the UE is to adjust the uplink transmission frequency of the UE by applying a frequency correction. For example, the UE may apply the frequency advance command and/or the frequency correction to the uplink frequency carrier while transmitting uplink symbols (e.g., PUSCH, PUCCH, and SRS). In some aspects, the NTN node may transmit two variants of the frequency advance command 705. For example, the first variant may include an initial frequency advance command via random access response message while communicating via PRACH resources for location information-less operations. The second variant may include a frequency advance command via MAC-CE for other operations and/or communications (e.g., using other resources). In some aspects, the UE may receive, from the NTN node, a configurable timer, such as frequencyAlignmentTimer. The UE may restarts the timer each time it receives an FAC. If the UE does not receive a frequency advance command within the expiry of the timer, the UE may assume a loss in uplink synchronization and/or alignment and may transition to the idle mode. For example, the UE may initiate the timer at time resource, n. In the example 700, a duration of the timer may be greater than the sum of time duration 710 and time duration 715.

In some aspects, the UE may receive a frequency advance command 705 for each timing advance group and/or frequency advance group with which the UE is associated. For example, for each group, the UE may receive a frequency advance command 705, F_{A}. The UE may be associated with more than one group when the UE communicates via carrier aggregation, and/or via multiple transmission reception points, among other examples. As a result, the UE may receive more than one frequency advance command and each frequency advance command may correspond to a group. Each timing and/or frequency advance group may be defined in the MAC layer of the UE and each timing and/or frequency advance group entity may correspond to a timing and/or frequency advance command.

In a first example, if the UE is not associated with a timing and/or frequency advance group, then the quantity of timing and/or frequency advance groups of tags may equal one, and the frequency advance command 705 uniquely corresponds to the uplink time resources.

In a second example, if the UE is associated with more than one timing and/or frequency advance group, then the frequency advance command 705 may indicate to which timing and/or frequency advance group the frequency correction and/or frequency advance corresponds. As a result, if there is more than one timing and/or frequency advance group associated with the UE, then for each group the UE may apply separate timing advance command and/or frequency advance command loops.

The UE may receive the frequency advance command 705 and may apply a frequency correction to the common FA to obtain a new FA 720. The UE may receive the frequency advance command 705 from the network node via the time resource, n. In such aspects, the corresponding advance of the uplink transmission frequency may be applied from the beginning of uplink time resource, n+k+1, where k is an amount of time 710 used to process downlink data messages and prepare uplink messages. The time resource, n, may be a lastly occurring time resource among uplink time resources that overlap with the downlink time resources, where the downlink message includes the timing advance command.

The UE may calculate the TA 725 from the FA 720 for an i^{th} time resource. For example, the UE may calculate:

$$\begin{matrix}{N}_{FA\_new} = {N}_{FA\_old} + γ ( {F}_{A} - k ) \\ {F}_{F A} = {N}_{F A} + {N}_{F A , c o m m o n} \\ {N}_{TA\_new}^{( 1 )} = {N}_{TA\_old}^{( 1 )} + α ( {F}_{A} - k ) S Δ t + β {N}_{FA , common} S Δ t\end{matrix}$$

where S is a scaling constant that is dependent on numerology; k depends on quantization levels of the frequency advance command 705; F_{FA} is the frequency advance computed for a timing and/or frequency advance group (e.g., which may have two components: accumulation of FACs, and/or the common FA);

$${N}_{TA\_new}^{( 1 )}$$

is the TA 725 computed from FA 720 (e.g., the TA 725 may include the integration of common frequency advances and the integration of FACs); α, and β are scaling factors determined by the UE and/or signaled by the network node so that the TA and FA loops do not diverge over time; Δt is the time elapsed between reception of the frequency advance command 705 and the time resource for which TA 725 is being calculated; and N_{FA,common}, is a network-controlled frequency correction and may be derived from higher-layer parameters.

For the uplink frame, i, the UE may apply

$${T}_{T A} = ( {N}_{TA} + {N}_{TA}^{( 1 )} + {N}_{TA , offset} + {N}_{TA , adj common} + {N}_{TA , adj UE} ) {T}_{c}$$

(e.g., as described with reference to FIG. 4) before the beginning of the corresponding downlink frame at the UE (e.g., time resource, n in the example 700). In some aspects, N_{TA} and

$${N}_{T A}^{( 1 )}$$

may not be active at the same time. For example, the UE may apply the new TA 725 to a time resource and may not apply both the old TA 725 and the new TA 725.

As such, TA 725 may be derived from the FA 720 without UE location information.

In some aspects, the UE may apply one or more FAs 720 (e.g., the FA obtained by applying the frequency correction to the common FA) to an uplink frequency carrier associated with uplink communication between the UE and the NTN node.

In some aspects, the UE may apply one or more FAs to a baseband frequency associated with uplink communication between the UE and the NTN node. For example, the UE may apply a time domain phase ramp to a first baseband frequency to obtain a baseband frequency for the uplink communications that accounts for the frequency correction (e.g., applies the FA 720). In some aspects, a time domain phase ramp may refer to a linear change in the phase of a signal as a function of time.

In some other aspects, the UE may apply the common frequency advance to an uplink frequency carrier associated with uplink communication between the UE and the NTN node and/or may apply one or more FAs 720 to a baseband frequency associated with uplink communication between the UE and the NTN node.

In some aspects, the UE may receive a frequency advance command during a first time resource (e.g., a slot, frame, subframe, among other examples), n, and may apply a frequency advance during a second time resource, n+k1+k2, where k1 is a duration of time used to process (e.g., receive, decode) a downlink data message (e.g., PDSCH), and k2 is a duration of time used to process (e.g., transmit, buffer) an uplink data message (e.g., PUSCH). Additionally or alternatively, the UE 120 may apply a timing advance during the second time resource, n+k1+k2. In some aspects, the UE may calculate a timing advance to apply to each time resource occurring subsequently to the second time resource, independently from additional frequency advance commands.

In such aspects, the TAs 725 may be derived from the FA 720, and as a result, if there is an FA 720, the UE may implicitly calculate the TAs 725. In such aspects, each time resource may be associated with a different TA 725 (e.g., TA 725a, TA 725b, or TA 725c) because the derivation of TAs 725 from FA 720 may be a function of the corresponding time resource. As such, the UE may calculate a new TA 725 for each time resource starting with time resource, n+k+1, until the UE receives a subsequent FAC. For example, the UE may apply the FA 720 and TA 725a to uplink communications via time resource, n+k+1; the UE may apply the FA 720 and TA 725b to uplink communications via time resource, n+k+2; and/or the UE may apply the FA 720 and TA 725c to uplink communications via time resource, n+k+3; and so on until the UE receives a second frequency advance command and applies and/or calculates a new FA 720 and/or new TAs 725.

As indicated above, FIG. 7 is provided as an example. Other examples may differ from what is described with respect to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with connected mode timing and frequency advances for NTNs.

As shown in FIG. 8, in some aspects, process 800 may include receiving, from a network node associated with an NTN, frequency and timing advance information in accordance with the UE operating in a location-independent communication mode (block 810). For example, the UE (e.g., using reception component 1002 and/or communication manager 1006, depicted in FIG. 10) may receive, from a network node associated with an NTN, frequency and timing advance information in accordance with the UE operating in a location-independent communication mode, as described above.

As further shown in FIG. 8, in some aspects, process 800 may include transmitting one or more uplink communications according to a frequency advance and a timing advance in association with receiving the frequency and timing advance information (block 820). For example, the UE (e.g., using transmission component 1004 and/or communication manager 1006, depicted in FIG. 10) may transmit one or more uplink communications according to a frequency advance and a timing advance in association with receiving the frequency and timing advance information, as described above.

Process 800 may include additional aspects, such as any single aspect or any combination of aspects described below and/or in connection with one or more other processes described elsewhere herein.

In a first aspect, process 800 includes receiving a frequency advance command including a frequency correction for uplink communications, and transmitting an additional one or more uplink communications according to the frequency correction and a timing correction that is calculated in association with receiving the frequency advance command.

In a second aspect, alone or in combination with the first aspect, receiving the frequency advance command comprises receiving, via a random access message, a first frequency correction for random access communications, and receiving, via a medium access control message, a second frequency correction for connected mode communications.

In a third aspect, alone or in combination with one or more of the first and second aspects, transmitting the additional one or more uplink communications according to the frequency correction and the timing correction comprises transmitting the additional one or more uplink communications in association with applying the frequency correction to an uplink carrier frequency associated with transmitting the one or more uplink communications, or transmitting the additional one or more uplink communications in association with applying the frequency correction to a baseband frequency associated with transmitting the one or more uplink communications

In a fourth aspect, alone or in combination with one or more of the first through third aspects, transmitting the one or more uplink communications according to the frequency advance and the timing advance comprises transmitting, via an uplink frequency carrier in accordance with the frequency advance, the one or more uplink communications, the method further comprising transmitting, via the uplink carrier frequency in accordance with the frequency advance, the additional one or more uplink communications in association with applying the frequency correction to a baseband frequency associated with transmitting the one or more uplink communications.

In a fifth aspect, alone or in combination with one or more of the first through fourth aspects, process 800 includes receiving, during a first time resource, a frequency advance command including a frequency correction associated with uplink communications, and transmitting, during a second time resource, an additional one or more uplink communications according to the frequency correction and a timing correction that is calculated in association with receiving the frequency advance command, wherein the second time resource occurs at a time offset, from the first time resource, that includes a downlink message processing duration and an uplink message preparation duration.

In a sixth aspect, alone or in combination with one or more of the first through fifth aspects, process 800 includes receiving, during a first time resource, a frequency advance command including a frequency correction for uplink communications during a second time resource, calculating a timing correction, as a function of the frequency advance, the frequency correction, and the timing advance, for the uplink communications during the second time resource, wherein the second time resource is offset from the first time resource by a quantity of time resources, and transmitting, during the second time resource, at least one uplink communication, of the set of one or more uplink communications, according to the frequency correction and the timing correction.

In a seventh aspect, alone or in combination with one or more of the first through sixth aspects, process 800 includes calculating an additional timing correction, as a function of the frequency correction and the timing correction, for uplink communications during a third time resource that is subsequent to the second time resource, and transmitting, during the third time resource, a second additional set of one or more uplink communications according to the frequency correction and the additional timing correction.

In an eighth aspect, alone or in combination with one or more of the first through seventh aspects, process 800 includes receiving a first frequency advance command including a first frequency correction for a first set of one or more uplink communications, and a second frequency advance command including a second frequency correction for a second set of one or more uplink communications, transmitting the first set of one or more uplink communications according to the first frequency correction and a first timing correction that is calculated in association with receiving the first frequency advance command, and transmitting the second set of one or more uplink communications according to the second frequency correction and a second timing correction that is calculated in association with receiving the second frequency advance command.

In a ninth aspect, alone or in combination with one or more of the first through eighth aspects, the first set of one or more uplink communications and the second set of one or more uplink communications are each associated with at least one of a respective uplink carrier frequency, a respective network node, a respective timing advance group, a respective frequency advance group, or a respective serving cell.

In a tenth aspect, alone or in combination with one or more of the first through ninth aspects, process 800 includes receiving a control message indicating a quantity of groups corresponding to a quantity of frequency advance commands for communicating respective sets of uplink communications.

In an eleventh aspect, alone or in combination with one or more of the first through tenth aspects, process 800 includes receiving an indication of a timer associated with uplink frequency synchronization, and performing at least one action in association with the timer expiring.

In a twelfth aspect, alone or in combination with one or more of the first through eleventh aspects, the at least one action comprises one or more of deleting contents in each of a quantity of buffers of the UE that are associated with a serving cell in a primary timing advance group, deleting contents in each of a quantity of buffers of the UE that are associated with a serving cell in a secondary timing advance group, transmitting a radio resource control message, to suspend communication of uplink control messages, to each serving cell associated with the UE, transmitting a radio resource control message, to suspend communication of sounding reference signal messages, to each serving cell associated with the UE, deleting one or more downlink assignments, deleting one or more uplink resource grants, or identifying that each timer, associated with uplink timing synchronization, of the UE has expired.

In a thirteenth aspect, alone or in combination with one or more of the first through twelfth aspects, the timer expiring is associated with an absence of a frequency advance command communication within an active duration of the timer.

In a fourteenth aspect, alone or in combination with one or more of the first through thirteenth aspects, process 800 includes identifying that a first timer associated with uplink timing synchronization for a secondary timing advance group has expired in association with a second timer, associated with uplink frequency synchronization for at least one of the secondary timing advance group or a primary timing advance group, expiring, and performing at least one action in association with the first timer expiring.

In a fifteenth aspect, alone or in combination with one or more of the first through fourteenth aspects, the at least one action comprises one or more of deleting contents in each of a quantity of buffers of the UE that are associated with a serving cell in the secondary timing advance group, or transmitting a radio resource control message, to suspend communication of sounding reference signal messages, to each serving cell in the secondary timing advance group.

In a sixteenth aspect, alone or in combination with one or more of the first through fifteenth aspects, process 800 includes receiving a first frequency advance command including a first frequency correction for a first set of one or more uplink communications, and initiating a timer associated with uplink frequency synchronization in association with receiving the first frequency advance command.

In a seventeenth aspect, alone or in combination with one or more of the first through sixteenth aspects, receiving the frequency and timing advance information comprises receiving at least one of a system information block including the frequency and timing advance information or a UE-specific message including the frequency and timing advance information.

In an eighteenth aspect, alone or in combination with one or more of the first through seventeenth aspects, the frequency and timing advance information includes a reference location, the method further comprising calculating the frequency advance and the timing advance in association with receiving the reference location.

In a nineteenth aspect, alone or in combination with one or more of the first through eighteenth aspects, the frequency advance comprises a frequency offset for frequency-domain scheduling of uplink communications to be transmitted via a communication relay device to the network node associated with the NTN.

In a twentieth aspect, alone or in combination with one or more of the first through nineteenth aspects, the timing advance comprises a timing offset for time-domain scheduling of uplink communications to be transmitted via a communication relay device to the network node associated with the NTN.

In a twenty-first aspect, alone or in combination with one or more of the first through twentieth aspects, the frequency advance is a UE-specific frequency advance, and the timing advance is a UE-specific timing advance.

In a twenty-second aspect, alone or in combination with one or more of the first through twenty-first aspects, the frequency advance is a cell-specific frequency advance, and the timing advance is a cell-specific timing advance.

In a twenty-third aspect, alone or in combination with one or more of the first through twenty-second aspects, the location-independent communication mode comprises at least one of a GNSS information-less communication mode, a radio resource control connected mode, or a UE location information-less communication mode.

In a twenty-fourth aspect, alone or in combination with one or more of the first through twenty-third aspects, the frequency and timing advance information includes at least one of an indication of the frequency advance, an indication of the timing advance, one or more derivatives of the frequency advance, one or more derivatives of the timing advance, a validity time value, a reference location for calculating the frequency advance, a drift associated with the reference location, or a drift rate associated with the reference location.

In a twenty-fifth aspect, alone or in combination with one or more of the first through twenty-fourth aspects, the one or more uplink communications include at least one of a physical uplink shared channel signal, a physical uplink control channel signal, or a synchronization reference signal.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a network node or an apparatus of a network node, in accordance with the present disclosure. Example process 900 is an example where the apparatus or the network node (e.g., network node 110) performs operations associated with connected mode timing and frequency advances for NTNs.

As shown in FIG. 9, in some aspects, process 900 may include transmitting, to a UE associated with an NTN, frequency and timing advance information in accordance with the UE operating in a location-independent communication mode (block 910). For example, the network node (e.g., using transmission component 1104 and/or communication manager 1106, depicted in FIG. 11) may transmit, to a UE associated with an NTN, frequency and timing advance information in accordance with the UE operating in a location-independent communication mode, as described above.

As further shown in FIG. 9, in some aspects, process 900 may include receiving one or more uplink communications according to a frequency advance and a timing advance in association with transmitting the frequency and timing advance information (block 920). For example, the network node (e.g., using reception component 1102 and/or communication manager 1106, depicted in FIG. 11) may receive one or more uplink communications according to a frequency advance and a timing advance in association with transmitting the frequency and timing advance information, as described above.

Process 900 may include additional aspects, such as any single aspect or any combination of aspects described below and/or in connection with one or more other processes described elsewhere herein.

In a first aspect, process 900 includes transmitting a frequency advance command including a frequency correction for uplink communications, and receiving an additional one or more uplink communications according to the frequency correction and a timing correction that is calculated in association with receiving the frequency advance command.

In a second aspect, alone or in combination with the first aspect, transmitting the frequency advance command comprises transmitting, via a random access message, a first frequency correction for random access communications, and transmitting, via a medium access control message, a second frequency correction for connected mode communications.

In a third aspect, alone or in combination with one or more of the first and second aspects, process 900 includes transmitting, during a first time resource, a frequency advance command including a frequency correction associated with uplink communications, and receiving, during a second time resource, an additional one or more uplink communications according to the frequency correction and a timing correction that is calculated in association with the frequency advance command.

In a fourth aspect, alone or in combination with one or more of the first through third aspects, process 900 includes transmitting a first frequency advance command including a first frequency correction for a first set of one or more uplink communications, and a second frequency advance command including a second frequency correction for a second set of one or more uplink communications, receiving the first set of one or more uplink communications according to the first frequency correction and a first timing correction that is calculated in association with receiving the first frequency advance command, and receiving the second set of one or more uplink communications according to the second frequency correction and a second timing correction that is calculated in association with receiving the second frequency advance command.

In a fifth aspect, alone or in combination with one or more of the first through fourth aspects, the first set of one or more uplink communications and the second set of one or more uplink communications are each associated with at least one of a respective uplink carrier frequency, a respective network node, a respective timing advance group, a respective frequency advance group, or a respective serving cell.

In a sixth aspect, alone or in combination with one or more of the first through fifth aspects, process 900 includes transmitting a control message indicating a quantity of groups corresponding to a quantity of frequency advance commands for communicating respective sets of uplink communications.

In a seventh aspect, alone or in combination with one or more of the first through sixth aspects, process 900 includes transmitting an indication of a timer associated with uplink frequency synchronization.

In an eighth aspect, alone or in combination with one or more of the first through seventh aspects, process 900 includes transmitting a first frequency advance command including a first frequency correction for a first set of one or more uplink communications, and initiating a timer associated with uplink frequency synchronization in association with receiving the first frequency advance command.

In a ninth aspect, alone or in combination with one or more of the first through eighth aspects, transmitting the frequency and timing advance information comprises transmitting at least one of a system information block including the frequency and timing advance information or a UE-specific message including the frequency and timing advance information.

In a tenth aspect, alone or in combination with one or more of the first through ninth aspects, the frequency advance comprises a frequency offset for frequency-domain scheduling of uplink communications to be transmitted via a communication relay device to the network node associated with the NTN.

In an eleventh aspect, alone or in combination with one or more of the first through tenth aspects, the timing advance comprises a timing offset for time-domain scheduling of uplink communications to be transmitted via a communication relay device to the network node associated with the NTN.

In a twelfth aspect, alone or in combination with one or more of the first through eleventh aspects, the frequency advance is a UE-specific frequency advance, and the timing advance is a UE-specific timing advance.

In a thirteenth aspect, alone or in combination with one or more of the first through twelfth aspects, the frequency advance is a cell-specific frequency advance, and the timing advance is a cell-specific timing advance.

In a fourteenth aspect, alone or in combination with one or more of the first through thirteenth aspects, the location-independent communication mode comprises at least one of a GNSS information-less communication mode, a radio resource control connected mode, or a UE location information-less communication mode.

In a fifteenth aspect, alone or in combination with one or more of the first through fourteenth aspects, the frequency and timing advance information includes at least one of an indication of the frequency advance, an indication of the timing advance, one or more derivatives of the frequency advance, one or more derivatives of the timing advance, a validity time value, a reference location for calculating the frequency advance, a drift associated with the reference location, or a drift rate associated with the reference location.

In a sixteenth aspect, alone or in combination with one or more of the first through fifteenth aspects, the one or more uplink communications include at least one of a physical uplink shared channel signal, a physical uplink control channel signal, or a synchronization reference signal.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 5-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a network node associated with an NTN, frequency and timing advance information in accordance with the UE operating in a location-independent communication mode. The transmission component 1004 may transmit one or more uplink communications according to a frequency advance and a timing advance in association with receiving the frequency and timing advance information.

The reception component 1002 may receive a frequency advance command including a frequency correction for uplink communications.

The transmission component 1004 may transmit an additional one or more uplink communications according to the frequency correction and a timing correction that is calculated in association with receiving the frequency advance command.

The reception component 1002 may receive, during a first time resource, a frequency advance command including a frequency correction associated with uplink communications.

The transmission component 1004 may transmit, during a second time resource, an additional one or more uplink communications according to the frequency correction and a timing correction that is calculated in association with receiving the frequency advance command, wherein the second time resource occurs at a time offset, from the first time resource, that includes a downlink message processing duration and an uplink message preparation duration.

The reception component 1002 may receive, during a first time resource, a frequency advance command including a frequency correction for uplink communications during a second time resource.

The communication manager 1006 may calculate a timing correction, as a function of the frequency advance, the frequency correction, and the timing advance, for the uplink communications during the second time resource, wherein the second time resource is offset from the first time resource by a quantity of time resources.

The transmission component 1004 may transmit, during the second time resource, at least one uplink communication, of the set of one or more uplink communications, according to the frequency correction and the timing correction.

The communication manager 1006 may calculate an additional timing correction, as a function of the frequency correction and the timing correction, for uplink communications during a third time resource that is subsequent to the second time resource.

The transmission component 1004 may transmit, during the third time resource, a second additional set of one or more uplink communications according to the frequency correction and the additional timing correction.

The reception component 1002 may receive a first frequency advance command including a first frequency correction for a first set of one or more uplink communications, and a second frequency advance command including a second frequency correction for a second set of one or more uplink communications.

The transmission component 1004 may transmit the first set of one or more uplink communications according to the first frequency correction and a first timing correction that is calculated in association with receiving the first frequency advance command.

The transmission component 1004 may transmit the second set of one or more uplink communications according to the second frequency correction and a second timing correction that is calculated in association with receiving the second frequency advance command.

The reception component 1002 may receive a control message indicating a quantity of groups corresponding to a quantity of frequency advance commands for communicating respective sets of uplink communications.

The reception component 1002 may receive an indication of a timer associated with uplink frequency synchronization.

The communication manager 1006 may perform at least one action in association with the timer expiring.

The communication manager 1006 may identify that a first timer associated with uplink timing synchronization for a secondary timing advance group has expired in association with a second timer, associated with uplink frequency synchronization for at least one of the secondary timing advance group or a primary timing advance group, expiring.

The communication manager 1006 may perform at least one action in association with the first timer expiring.

The reception component 1002 may receive a first frequency advance command including a first frequency correction for a first set of one or more uplink communications.

The communication manager 1006 may initiate a timer associated with uplink frequency synchronization in association with receiving the first frequency advance command.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node, or a network node may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 155 described in connection with FIG. 1. As shown, the apparatus 1100 may communicate with another apparatus 1108, such as a UE or a network node (such as a CU, a DU, an RU, or a base station), using the reception component 1102 and the transmission component 1104. The communication manager 1106 may be included in, or implemented via, a processing system (for example, the processing system 145 described in connection with FIG. 1) of the network node.

In some aspects, the apparatus 1100 may be configured to perform one or more operations described herein in connection with FIGS. 5-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 May include one or more components of the network node described in connection with FIG. 1. Additionally, or alternatively, one or more components shown in FIG. 11 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications, and may provide the processed signals to the one or more other components of the apparatus 1100. In some aspects, the reception component 1102 may include one or more components of the network node described above in connection with FIG. 1, such as a radio, one or more RF chains, one or more transceivers, or one or more modems, each of which may in turn be coupled with one or more antennas of the network node. In some aspects, the reception component 1102 and/or the transmission component 1104 may include or may be included in a network interface. The network interface may be configured to obtain and/or output signals for the apparatus 1100 via one or more communications links, such as a backhaul link, a midhaul link, and/or a fronthaul link.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications, and may transmit the processed signals to the apparatus 1108. In some aspects, the transmission component 1104 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1104 may be co-located with the reception component 1102.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a UE associated with an NTN, frequency and timing advance information in accordance with the UE operating in a location-independent communication mode. The reception component 1102 may receive one or more uplink communications according to a frequency advance and a timing advance in association with transmitting the frequency and timing advance information.

The transmission component 1104 may transmit a frequency advance command including a frequency correction for uplink communications.

The reception component 1102 may receive an additional one or more uplink communications according to the frequency correction and a timing correction that is calculated in association with receiving the frequency advance command.

The transmission component 1104 may transmit, during a first time resource, a frequency advance command including a frequency correction associated with uplink communications.

The reception component 1102 may receive, during a second time resource, an additional one or more uplink communications according to the frequency correction and a timing correction that is calculated in association with the frequency advance command.

The transmission component 1104 may transmit a first frequency advance command including a first frequency correction for a first set of one or more uplink communications, and a second frequency advance command including a second frequency correction for a second set of one or more uplink communications.

The reception component 1102 may receive the first set of one or more uplink communications according to the first frequency correction and a first timing correction that is calculated in association with receiving the first frequency advance command.

The reception component 1102 may receive the second set of one or more uplink communications according to the second frequency correction and a second timing correction that is calculated in association with receiving the second frequency advance command.

The transmission component 1104 may transmit a control message indicating a quantity of groups corresponding to a quantity of frequency advance commands for communicating respective sets of uplink communications.

The transmission component 1104 may transmit an indication of a timer associated with uplink frequency synchronization.

The transmission component 1104 may transmit a first frequency advance command including a first frequency correction for a first set of one or more uplink communications.

The communication manager 1106 may initiate a timer associated with uplink frequency synchronization in association with receiving the first frequency advance command.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving, from a network node associated with a non-terrestrial network, frequency and timing advance information in accordance with the UE operating in a location-independent communication mode; and transmitting one or more uplink communications according to a frequency advance and a timing advance in association with receiving the frequency and timing advance information.

Aspect 2: The method of Aspect 1, further comprising: receiving a frequency advance command including a frequency correction for uplink communications; and transmitting an additional one or more uplink communications according to the frequency correction and a timing correction that is calculated in association with receiving the frequency advance command.

Aspect 3: The method of Aspect 2, wherein receiving the frequency advance command comprises: receiving, via a random access message, a first frequency correction for random access communications; and receiving, via a medium access control message, a second frequency correction for connected mode communications.

Aspect 4: The method of any of Aspect 2-3, wherein transmitting the additional one or more uplink communications according to the frequency correction and the timing correction comprises: transmitting the additional one or more uplink communications in association with applying the frequency correction to an uplink carrier frequency associated with transmitting the one or more uplink communications, or transmitting the additional one or more uplink communications in association with applying the frequency correction to a baseband frequency associated with transmitting the one or more uplink communications

Aspect 5: The method of any of Aspect 2-3, wherein transmitting the one or more uplink communications according to the frequency advance and the timing advance comprises: transmitting, via an uplink frequency carrier in accordance with the frequency advance, the one or more uplink communications, the method further comprising: transmitting, via the uplink carrier frequency in accordance with the frequency advance, the additional one or more uplink communications in association with applying the frequency correction to a baseband frequency associated with transmitting the one or more uplink communications.

Aspect 6: The method of any of Aspects 1-5, further comprising: receiving, during a first time resource, a frequency advance command including a frequency correction associated with uplink communications; and transmitting, during a second time resource, an additional one or more uplink communications according to the frequency correction and a timing correction that is calculated in association with receiving the frequency advance command, wherein the second time resource occurs at a time offset, from the first time resource, that includes a downlink message processing duration and an uplink message preparation duration.

Aspect 7: The method of any of Aspects 1-6, further comprising: receiving, during a first time resource, a frequency advance command including a frequency correction for uplink communications during a second time resource; calculating a timing correction, as a function of the frequency advance, the frequency correction, and the timing advance, for the uplink communications during the second time resource, wherein the second time resource is offset from the first time resource by a quantity of time resources; and transmitting, during the second time resource, at least one uplink communication, of the set of one or more uplink communications, according to the frequency correction and the timing correction.

Aspect 8: The method of Aspect 7, further comprising: calculating an additional timing correction, as a function of the frequency correction and the timing correction, for uplink communications during a third time resource that is subsequent to the second time resource; and transmitting, during the third time resource, a second additional set of one or more uplink communications according to the frequency correction and the additional timing correction.

Aspect 9: The method of any of Aspects 1-8, further comprising: receiving a first frequency advance command including a first frequency correction for a first set of one or more uplink communications, and a second frequency advance command including a second frequency correction for a second set of one or more uplink communications; transmitting the first set of one or more uplink communications according to the first frequency correction and a first timing correction that is calculated in association with receiving the first frequency advance command; and transmitting the second set of one or more uplink communications according to the second frequency correction and a second timing correction that is calculated in association with receiving the second frequency advance command.

Aspect 10: The method of Aspect 9, wherein the first set of one or more uplink communications and the second set of one or more uplink communications are each associated with at least one of: a respective uplink carrier frequency, a respective network node, a respective timing advance group, a respective frequency advance group, or a respective serving cell.

Aspect 11: The method of any of Aspects 1-10, further comprising: receiving a control message indicating a quantity of groups corresponding to a quantity of frequency advance commands for communicating respective sets of uplink communications.

Aspect 12: The method of any of Aspects 1-11, further comprising: receiving an indication of a timer associated with uplink frequency synchronization; and performing at least one action in association with the timer expiring.

Aspect 13: The method of Aspect 12, wherein the at least one action comprises one or more of: deleting contents in each of a quantity of buffers of the UE that are associated with a serving cell in a primary timing advance group, deleting contents in each of a quantity of buffers of the UE that are associated with a serving cell in a secondary timing advance group, transmitting a radio resource control message, to suspend communication of uplink control messages, to each serving cell associated with the UE, transmitting a radio resource control message, to suspend communication of sounding reference signal messages, to each serving cell associated with the UE, deleting one or more downlink assignments, deleting one or more uplink resource grants, or identifying that each timer, associated with uplink timing synchronization, of the UE has expired.

Aspect 14: The method of any of Aspects 12-13, wherein the timer expiring is associated with an absence of a frequency advance command communication within an active duration of the timer.

Aspect 15: The method of any of Aspects 1-14, further comprising: identifying that a first timer associated with uplink timing synchronization for a secondary timing advance group has expired in association with a second timer, associated with uplink frequency synchronization for at least one of the secondary timing advance group or a primary timing advance group, expiring; and performing at least one action in association with the first timer expiring.

Aspect 16: The method of Aspect 15, wherein the at least one action comprises one or more of: deleting contents in each of a quantity of buffers of the UE that are associated with a serving cell in the secondary timing advance group, or transmitting a radio resource control message, to suspend communication of sounding reference signal messages, to each serving cell in the secondary timing advance group.

Aspect 17: The method of any of Aspects 1-16, further comprising: receiving a first frequency advance command including a first frequency correction for a first set of one or more uplink communications; and initiating a timer associated with uplink frequency synchronization in association with receiving the first frequency advance command.

Aspect 18: The method of any of Aspects 1-17, wherein receiving the frequency and timing advance information comprises: receiving at least one of a system information block including the frequency and timing advance information or a UE-specific message including the frequency and timing advance information.

Aspect 19: The method of any of Aspects 1-18, wherein the frequency and timing advance information includes a reference location, the method further comprising: calculating the frequency advance and the timing advance in association with receiving the reference location.

Aspect 20: The method of any of Aspects 1-19, wherein the frequency advance comprises a frequency offset for frequency-domain scheduling of uplink communications to be transmitted via a communication relay device to the network node associated with the non-terrestrial network.

Aspect 21: The method of any of Aspects 1-20, wherein the timing advance comprises a timing offset for time-domain scheduling of uplink communications to be transmitted via a communication relay device to the network node associated with the non-terrestrial network.

Aspect 22: The method of any of Aspects 1-21, wherein the frequency advance is a UE-specific frequency advance, and the timing advance is a UE-specific timing advance.

Aspect 23: The method of any of Aspects 1-22, wherein the frequency advance is a cell-specific frequency advance, and the timing advance is a cell-specific timing advance.

Aspect 24: The method of any of Aspects 1-23, wherein the location-independent communication mode comprises at least one of a global navigation satellite system (GNSS) information-less communication mode, a radio resource control connected mode, or a UE location information-less communication mode.

Aspect 25: The method of any of Aspects 1-24, wherein the frequency and timing advance information includes at least one of: an indication of the frequency advance, an indication of the timing advance, one or more derivatives of the frequency advance, one or more derivatives of the timing advance, a validity time value, a reference location for calculating the frequency advance, a drift associated with the reference location, or a drift rate associated with the reference location.

Aspect 26: The method of any of Aspects 1-25, wherein the one or more uplink communications include at least one of a physical uplink shared channel signal, a physical uplink control channel signal, or a synchronization reference signal.

Aspect 27: A method of wireless communication performed by a network node, comprising: transmitting, to a user equipment (UE) associated with a non-terrestrial network, frequency and timing advance information in accordance with the UE operating in a location-independent communication mode; and receiving one or more uplink communications according to a frequency advance and a timing advance in association with transmitting the frequency and timing advance information.

Aspect 28: The method of Aspect 27, further comprising: transmitting a frequency advance command including a frequency correction for uplink communications; and receiving an additional one or more uplink communications according to the frequency correction and a timing correction that is calculated in association with receiving the frequency advance command.

Aspect 29: The method of Aspect 28, wherein transmitting the frequency advance command comprises: transmitting, via a random access message, a first frequency correction for random access communications; and transmitting, via a medium access control message, a second frequency correction for connected mode communications.

Aspect 30: The method of any of Aspects 27-29, further comprising: transmitting, during a first time resource, a frequency advance command including a frequency correction associated with uplink communications; and receiving, during a second time resource, an additional one or more uplink communications according to the frequency correction and a timing correction that is calculated in association with the frequency advance command.

Aspect 31: The method of any of Aspects 27-30, further comprising: transmitting a first frequency advance command including a first frequency correction for a first set of one or more uplink communications, and a second frequency advance command including a second frequency correction for a second set of one or more uplink communications; receiving the first set of one or more uplink communications according to the first frequency correction and a first timing correction that is calculated in association with receiving the first frequency advance command; and receiving the second set of one or more uplink communications according to the second frequency correction and a second timing correction that is calculated in association with receiving the second frequency advance command.

Aspect 32: The method of Aspect 31, wherein the first set of one or more uplink communications and the second set of one or more uplink communications are each associated with at least one of: a respective uplink carrier frequency, a respective network node, a respective timing advance group, a respective frequency advance group, or a respective serving cell.

Aspect 33: The method of any of Aspects 27-32, further comprising: transmitting a control message indicating a quantity of groups corresponding to a quantity of frequency advance commands for communicating respective sets of uplink communications.

Aspect 34: The method of any of Aspects 27-33, further comprising: transmitting an indication of a timer associated with uplink frequency synchronization.

Aspect 35: The method of any of Aspects 27-34, further comprising: transmitting a first frequency advance command including a first frequency correction for a first set of one or more uplink communications; and initiating a timer associated with uplink frequency synchronization in association with receiving the first frequency advance command.

Aspect 36: The method of any of Aspects 27-35, wherein transmitting the frequency and timing advance information comprises: transmitting at least one of a system information block including the frequency and timing advance information or a UE-specific message including the frequency and timing advance information.

Aspect 37: The method of any of Aspects 27-36, wherein the frequency advance comprises a frequency offset for frequency-domain scheduling of uplink communications to be transmitted via a communication relay device to the network node associated with the non-terrestrial network.

Aspect 38: The method of any of Aspects 27-37, wherein the timing advance comprises a timing offset for time-domain scheduling of uplink communications to be transmitted via a communication relay device to the network node associated with the non-terrestrial network.

Aspect 39: The method of any of Aspects 27-38, wherein the frequency advance is a UE-specific frequency advance, and the timing advance is a UE-specific timing advance.

Aspect 40: The method of any of Aspects 27-39, wherein the frequency advance is a cell-specific frequency advance, and the timing advance is a cell-specific timing advance.

Aspect 41: The method of any of Aspects 27-40, wherein the location-independent communication mode comprises at least one of a global navigation satellite system (GNSS) information-less communication mode, a radio resource control connected mode, or a UE location information-less communication mode.

Aspect 42: The method of any of Aspects 27-41, wherein the frequency and timing advance information includes at least one of: an indication of the frequency advance, an indication of the timing advance, one or more derivatives of the frequency advance, one or more derivatives of the timing advance, a validity time value, a reference location for calculating the frequency advance, a drift associated with the reference location, or a drift rate associated with the reference location.

Aspect 43: The method of any of Aspects 27-42, wherein the one or more uplink communications include at least one of a physical uplink shared channel signal, a physical uplink control channel signal, or a synchronization reference signal.

Aspect 44: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-43.

Aspect 45: An apparatus for wireless communication at a device, the apparatus comprising one or more memories and one or more processors coupled to the one or more memories, the one or more processors configured to cause the device to perform the method of one or more of Aspects 1-43.

Aspect 46: An apparatus for wireless communication, the apparatus comprising at least one means for performing the method of one or more of Aspects 1-43.

Aspect 47: A non-transitory computer-readable medium storing code for wireless communication, the code comprising instructions executable by one or more processors to perform the method of one or more of Aspects 1-43.

Aspect 48: A non-transitory computer-readable medium storing a set of instructions for wireless communication, the set of instructions comprising one or more instructions that, when executed by one or more processors of a device, cause the device to perform the method of one or more of Aspects 1-43.

Aspect 49: A device for wireless communication, the device comprising a processing system that includes one or more processors and one or more memories coupled with the one or more processors, the processing system configured to cause the device to perform the method of one or more of Aspects 1-43.

Aspect 50: An apparatus for wireless communication at a device, the apparatus comprising one or more memories and one or more processors coupled to the one or more memories, the one or more processors individually or collectively configured to cause the device to perform the method of one or more of Aspects 1-43.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive, from a network node associated with a non-terrestrial network, frequency and timing advance information in accordance with the UE operating in a location-independent communication mode; and
transmit one or more uplink communications according to a frequency advance and a timing advance in association with receiving the frequency and timing advance information.

2. The apparatus of claim 1, wherein the one or more processors are further configured to cause the UE to:
receive a frequency adjustment command including a frequency correction for uplink communications; and
transmit an additional one or more uplink communications according to the frequency correction and a timing correction that is calculated in association with receiving the frequency adjustment command.

3. The apparatus of claim 2, wherein the one or more processors, to cause the UE to receive the frequency adjustment command, are configured to cause the UE to:
receive, via a random access message, a first frequency correction for random access communications; and
receive, via a medium access control message, a second frequency correction for connected mode communications.

4. The apparatus of claim 2, wherein the one or more processors, to cause the UE to transmit the additional one or more uplink communications according to the frequency correction and the timing correction, are configured to cause the UE to:
transmit the additional one or more uplink communications in association with applying the frequency correction to an uplink carrier frequency associated with transmitting the one or more uplink communications, or
transmit the additional one or more uplink communications in association with applying the frequency correction to a baseband frequency associated with transmitting the one or more uplink communications.

5. The apparatus of claim 2, wherein the one or more processors, to cause the UE to transmit the one or more uplink communications according to the frequency advance and the timing advance, are configured to cause the UE to:
transmit, via an uplink frequency carrier in accordance with the frequency advance, the one or more uplink communications, the method further comprising:
transmit, via the uplink carrier frequency in accordance with the frequency advance, the additional one or more uplink communications in association with applying the frequency correction to a baseband frequency associated with transmitting the one or more uplink communications.

6. The apparatus of claim 1, wherein the one or more processors are further configured to cause the UE to:
receive, during a first time resource, a frequency adjustment command including a frequency correction associated with uplink communications; and
transmit, during a second time resource, an additional one or more uplink communications according to the frequency correction and a timing correction that is calculated in association with receiving the frequency adjustment command, wherein the second time resource occurs at a time offset, from the first time resource, that includes a downlink message processing duration and an uplink message preparation duration.

7. The apparatus of claim 1, wherein the one or more processors are further configured to cause the UE to:
receive, during a first time resource, a frequency adjustment command including a frequency correction for uplink communications during a second time resource;
calculate a timing correction, as a function of the frequency advance, the frequency correction, and the timing advance, for the uplink communications during the second time resource, wherein the second time resource is offset from the first time resource by a quantity of time resources; and
transmit, during the second time resource, at least one uplink communication of the set of one or more uplink communications according to the frequency correction and the timing correction.

8. The apparatus of claim 1, wherein the one or more processors are further configured to cause the UE to:
receive a first frequency adjustment command including a first frequency correction for a first set of one or more uplink communications, and a second frequency adjustment command including a second frequency correction for a second set of one or more uplink communications;
transmit the first set of one or more uplink communications according to the first frequency correction and a first timing correction that is calculated in association with receiving the first frequency adjustment command; and
transmit the second set of one or more uplink communications according to the second frequency correction and a second timing correction that is calculated in association with receiving the second frequency adjustment command.

9. The apparatus of claim 8, wherein the first set of one or more uplink communications and the second set of one or more uplink communications are each associated with at least one of:
a respective uplink carrier frequency,
a respective network node,
a respective timing advance group,
a respective frequency advance group, or
a respective serving cell.

10. A method of wireless communication performed by a user equipment (UE), comprising:
receiving, from a network node associated with a non-terrestrial network, frequency and timing advance information in accordance with the UE operating in a location-independent communication mode; and
transmitting one or more uplink communications according to a frequency advance and a timing advance in association with receiving the frequency and timing advance information.

11. The method of claim 10, further comprising:
receiving a control message indicating a quantity of groups corresponding to a quantity of frequency adjustment commands for communicating respective sets of uplink communications.

12. The method of claim 10, further comprising:
receiving an indication of a timer associated with uplink frequency synchronization; and
performing at least one action in association with the timer expiring.

13. The method of claim 12, wherein the at least one action comprises one or more of:
deleting contents in each of a quantity of buffers of the UE that are associated with a serving cell in a primary timing advance group,
deleting contents in each of a quantity of buffers of the UE that are associated with a serving cell in a secondary timing advance group,
transmitting a radio resource control message, to suspend communication of uplink control messages, to each serving cell associated with the UE, transmitting a radio resource control message, to suspend communication of sounding reference signal messages, to each serving cell associated with the UE,
deleting one or more downlink assignments,
deleting one or more uplink resource grants, or
identifying that each timer, associated with uplink timing synchronization, of the UE has expired.

14. The method of claim 12 wherein the timer expiring is associated with an absence of a frequency adjustment command communication within an active duration of the timer.

15. A non-transitory computer-readable medium storing a set of instructions for wireless communication, the set of instructions comprising:
one or more instructions that, when executed by one or more processors of a user equipment (UE), cause the UE to:
receive, from a network node associated with a non-terrestrial network, frequency and timing advance information in accordance with the UE operating in a location-independent communication mode; and
transmit one or more uplink communications according to a frequency advance and a timing advance in association with receiving the frequency and timing advance information.

16. The non-transitory computer-readable medium of claim 15, wherein the one or more instructions further cause the UE to:
identify that a first timer associated with uplink timing synchronization for a secondary timing advance group has expired in association with a second timer, associated with uplink frequency synchronization for at least one of the secondary timing advance group or a primary timing advance group, expiring; and
perform at least one action in association with the first timer expiring.

17. The non-transitory computer-readable medium of claim 15, wherein the one or more instructions, that cause the UE to receive the frequency and timing advance information, cause the UE to:
receive at least one of a system information block including the frequency and timing advance information or a UE-specific message including the frequency and timing advance information.

18. The non-transitory computer-readable medium of claim 15, wherein the one or more instructions further cause the UE to a reference location, the method further comprising:
calculate the frequency advance and the timing advance in association with receiving the reference location.

19. The non-transitory computer-readable medium of claim 15, wherein the frequency advance comprises a frequency offset for frequency-domain scheduling of uplink communications to be transmitted via a communication relay device to the network node associated with the non-terrestrial network.

20. The non-transitory computer-readable medium of claim 15, wherein the timing advance comprises a timing offset for time-domain scheduling of uplink communications to be transmitted via a communication relay device to the network node associated with the non-terrestrial network.
